(19) United States
(12) Patent Application Publication
(10) Pub. No.: US 2008/0164354 A1
(43) Pub. Date: Jul. 10, 2008

(54) Noise reduction motor and components for shredder

(76) Inventor: Simon Huang, Taipei (TW)

Correspondence Address: SEDGWICK, DETERT, MORAN & ARNOLD, LLP (LA), 801 SOUTH FIGUEROA ST., 18TH FLOOR, LOS ANGELES, CA, 90017, US

(21) Appl. No.: 11/975,993

(22) Filed: Oct. 23, 2007

Related U.S. Application Data
(63) Continuation-in-part of application No. 11/650,266, filed on Jan. 5, 2007.

(51) Int. Cl. B02C 18/10

(52) U.S. Cl. 241/221

(57) ABSTRACT

The present invention relates generally to shredder noise reduction. Specifically, this invention discloses shredder motor gears and belts which are coated with a dampening material to reduce noise. When belt assemblies are used to couple the motor to the rotary cutting shafts, a pronounced decrease in noise is found. Additionally, the invention discloses the placement of vibration absorbers between the motor assembly and the shredder housing, as well as the rotary cutting assembly and shredder housing, thus further facilitating noise reduction.

### CLAIM OF PRIORITY

This application is a continuation-in-part application to U.S. Ser. No. 11/650,266 which was filed on Jan. 5, 2008.

### BACKGROUND OF THE INVENTION

1. Field of the Invention

The present invention relates generally to shredder motors, the coupling of the shredder motors to the rotary cutting shaft, and the coupling of the motor housing to the shredder housing. Specifically, this invention discloses shredder motor gears and belts which are coated to reduce the output noise from a shredder. The invention further discloses that when additional series of belts and gears are linked between the motor and rotary cutting shafts, shredder noise output is further reduced. Additionally, the invention discloses the placement of vibration absorbers between the motor assembly and the shredder housing, as well as between the rotary cutting assembly and shredder housing, thus further facilitating noise reduction.

2. Background Information

With increased privacy concerns, shredders have become an integral part in both homes and businesses. Though originally used to destroy paper products, shredders are now used to shred other forms of media that hold information, such as compact discs. In addition, credit cards and other plastic products are commonly shredded.

Shredders typically use an AC motor, DC motor, or capacitor motor. The typical AC motor spins faster than a DC motor which spins faster than the capacitor motor. However, the slower spinning motors may have more torque.

Shredders create a substantial amount of noise because the shredding mechanism is comprised of a motor driven by gears that are made of steel. Since the gears are made of steel, the teeth of the gears cause vibration and noise when they interlock. In addition, both the motor assembly and rotary cutting assembly are directly coupled to the shredder housing leading to a direct transfer of the noise and vibration to the shredder housing. In general, the faster spinning motors create more noise.

The present invention employs a coating such as rubber around the gears to reduce noise and vibration. In addition, rather than have the gears directly interlock with other gears, a belt may be used to connect the gears. The belt may also be coated with rubber, or a like substance to provide further noise reduction. When additional series of belts assemblies are linked between the motor and rotary cutting shafts, shredder noise output is further reduced. Finally, vibration absorbers may be used to couple the motor assembly and rotary cutting assembly to the shredder housing.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a shredder with decreased noise output. In one preferred embodiment, gears typically made of steel are coated with rubber or a like substance. Rather than have the noise and vibration from steel to steel contact reverberate throughout the shredder, the rubber coated gears dampen both the noise and vibration. In addition, rather than have gears directly interlock, a belt coated with rubber, or a like substance, can lead to further noise and vibration dampening. When additional belt assemblies are linked between the motor and rotary cutting shafts, shredder noise output is further reduced. Finally, vibration absorbers may be used to couple the motor assembly and rotary cutting assembly to the shredder housing thus further reducing the vibration and noise emanating from the motor.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a top plan view of a shredder housing and shredder mechanism embodying features of the prior art.

FIG. 2 is a cross sectional side view of a shredder housing and shredder mechanism embodying features of the prior art.

FIG. 3 is a side view of a gear embodying features of this invention.

FIG. 4 is an exploded side view of the teeth of a gear embodying features of this invention.

FIG. 5 is a side view of a belt and gears embodying features of this invention.

FIG. 6 is a top plan view of a shredder housing and shredder mechanism embodying features of this invention.

FIG. 7 is a cross sectional side view of a shredder housing and shredder mechanism embodying features of this invention.

FIG. 8 a top plan view of a motor, belt assembly and gears embodying features of the present invention.

FIG. 9 is a side view of a belt assembly and gears embodying features of this invention.

FIG. 10 is a cross sectional side view of a shredder housing and shredder mechanism embodying features of this invention.

FIG. 11 a top plan view of a motor, belt assembly, gears, and rotary cutting shaft embodying features of the present invention.

### DETAILED DESCRIPTION OF THE INVENTION

The essential elements of a shredder are comprised of a base (not shown), a housing 1, and a shredder mechanism 2 which resides in the housing. The housing 1 is comprised of a throat 2 through which materials to be shredded are fed. The materials are shredded in a shredder mechanism 3 which is comprised of a rotary cutting assembly 4 and a motor assembly S.

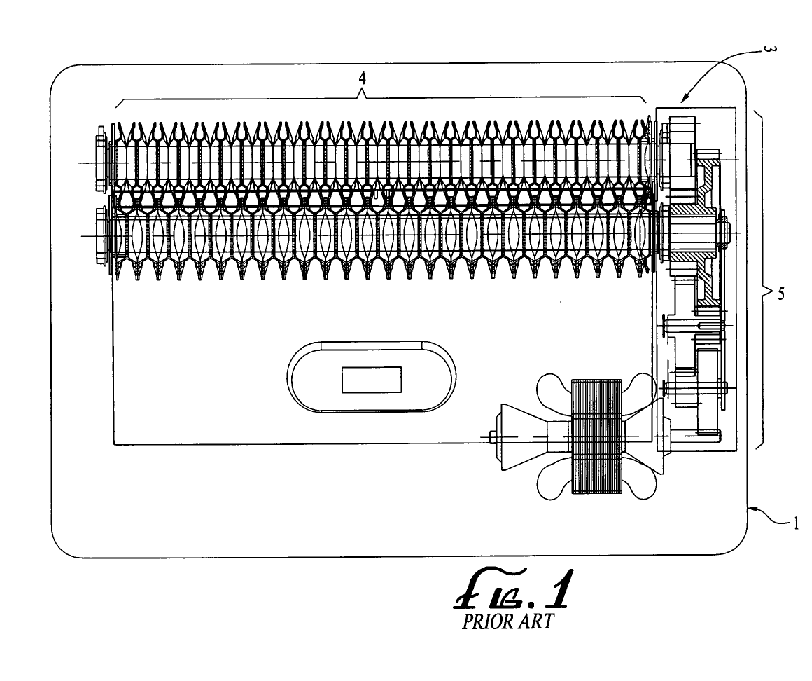

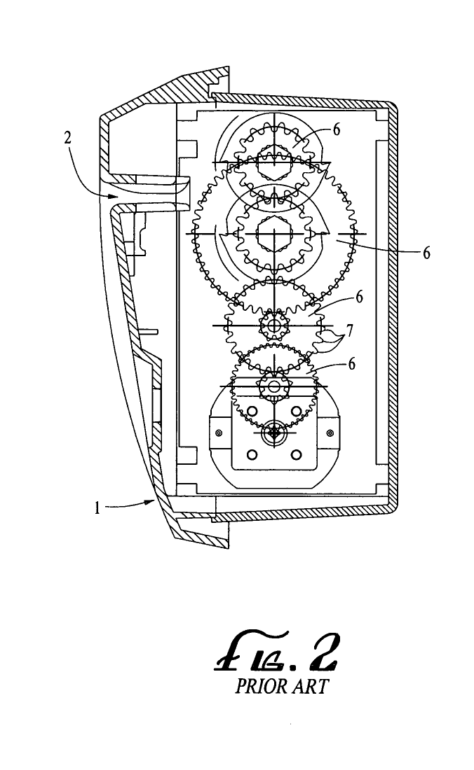

Typically the gears 6 of the motor assembly 4 are made of a hardened metal such as steel. As seen in the prior art in FIGS. 1 and 2, the gears 6 have teeth 7 which align and transfer rotary power to the rotary cutting assembly 4. In addition the motor assembly 5 is coupled directly to the shredder housing 1.

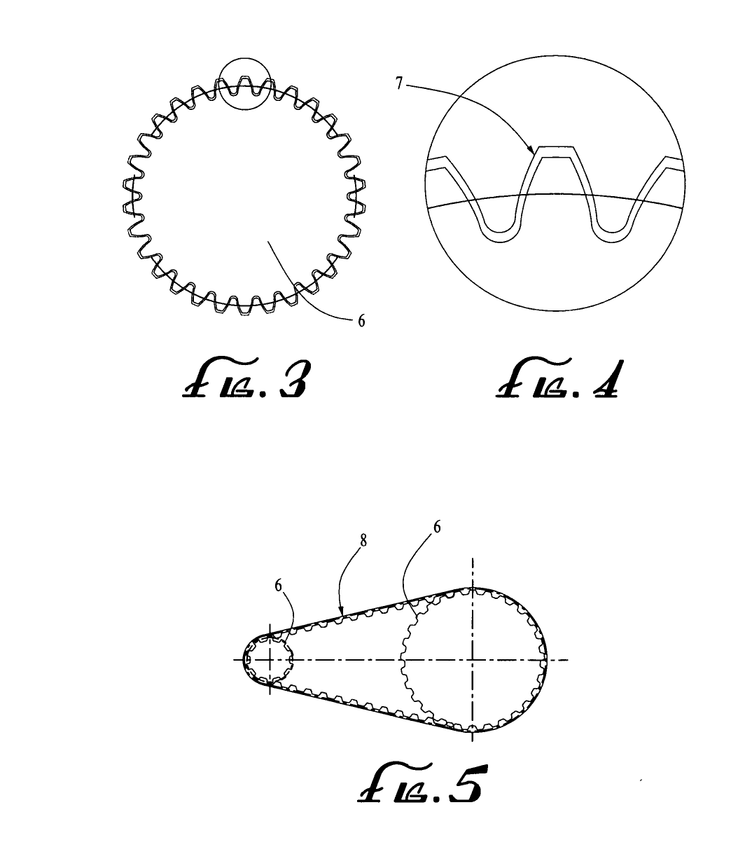

In this preferred embodiment the motor assembly 5 is comprised of at least one coated gear. FIGS. 3 and 4 disclose a coated gear 6. The gear is preferably coated by with silicon rubber or polyurethane and Teflon. The coating provides a noise and vibration dampening effect when the teeth of the gear are in contact with another gear or belt.

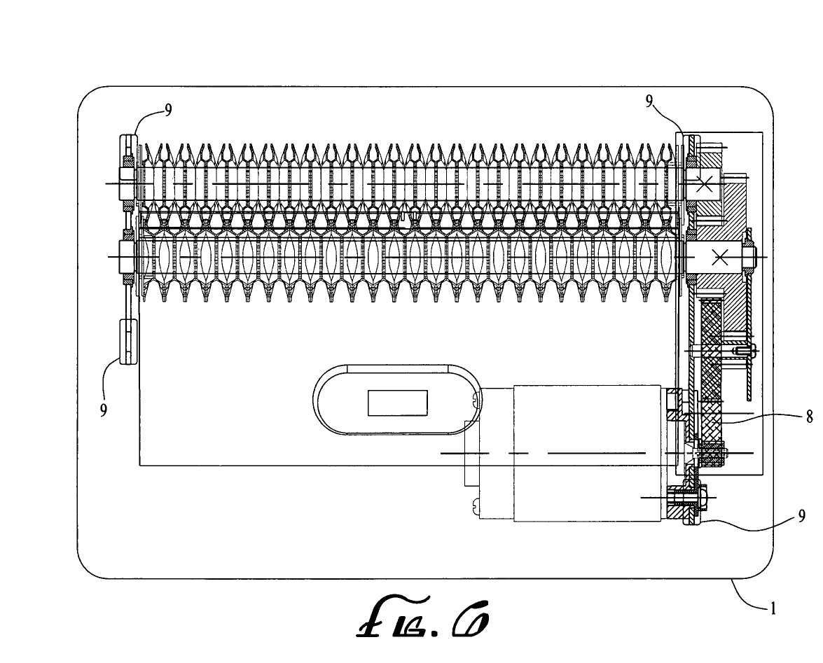

To further reduce noise, rather than have gears contact each other directly in the motor assembly, a belt can be used to connect the gears. FIG. 5 shows a coated belt 8 connecting two coated gears. The belt is preferably coated with rubber or silicon rubber.

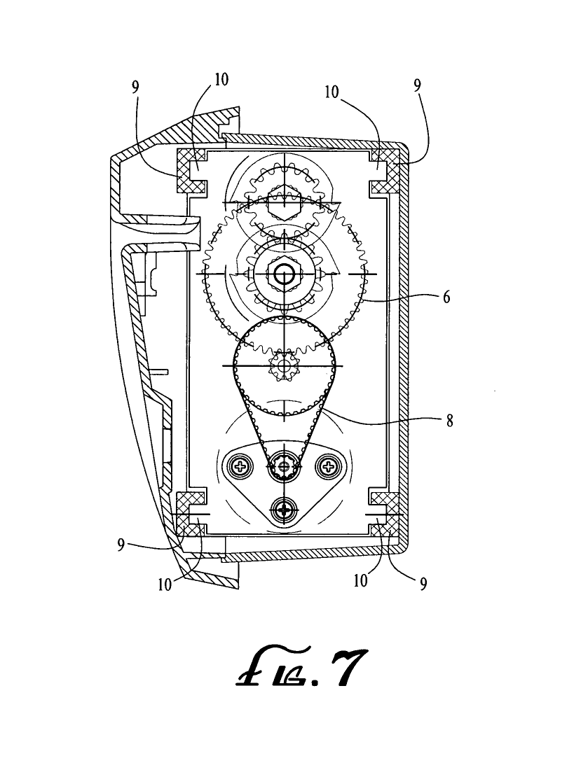

Finally, as demonstrated in FIGS. 6, 7, and 11 vibration absorbers 9 may be used to couple the motor assembly 5 and/or the rotary cutting assembly 4 to the housing 1. The vibration absorbers 9 are preferably made of rubber or silicon rubber molded in a U-shape. The vibration absorbers 9 can then be readily fastened to a projection 10 from the motor assembly 5 or rotary cutting assembly 4. The use of vibration absorbers to couple the motor assembly to the housing further reduces noise by absorbing the noise and vibration that is typically relayed from the coupling of the motor assembly to the housing or the rotary cutting assembly to the housing.

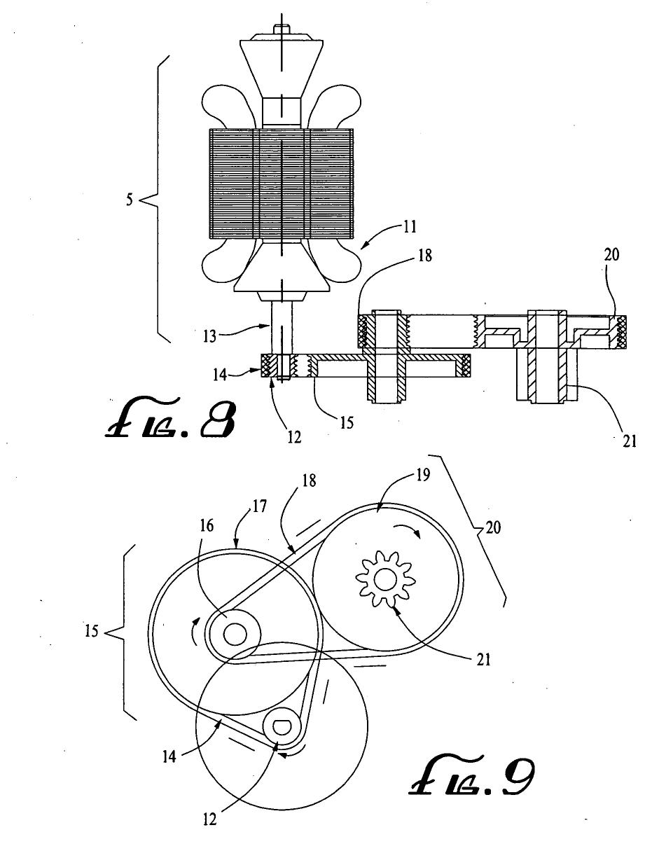

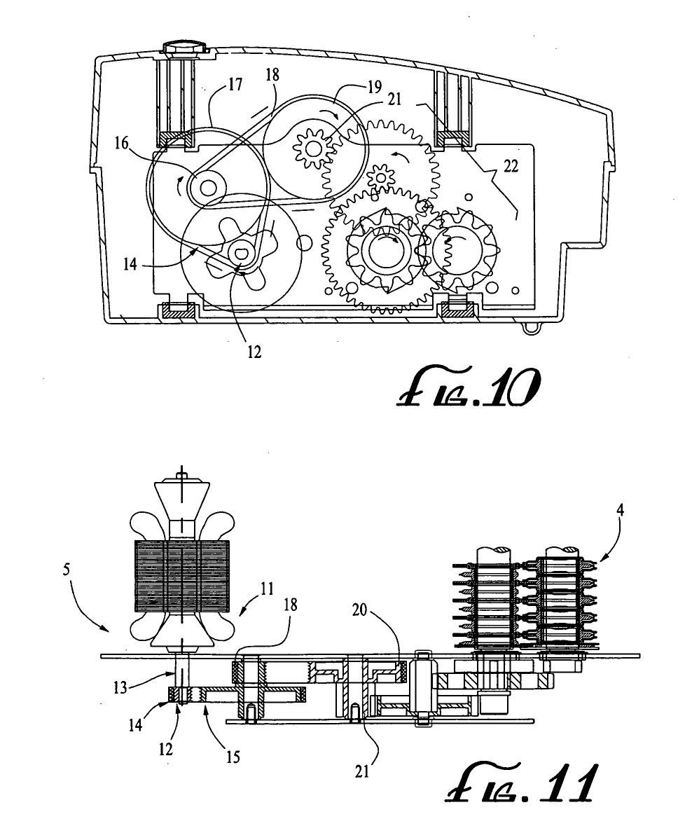

When additional belt assemblies are added, noise emanating from the shredder is further dampened. FIGS. 8-11 disclose the addition of another belt assembly 11 to form a two belt assembly. This belt assembly couples the motor assembly 5 and the rotary cutting assembly 4.

As seen in FIGS. 8-11, a motor 11 with a pulley wheel 12 at the end of the driving shaft 13 connects a first belt 14 to a first belt wheel 15 which is comprised of a small diameter pulley wheel 16 and large diameter pulley wheel 17. This first belt 15 connects the motor pulley wheel 12 to the large diameter pulley 17 of the first belt wheel 15. A second belt 18 then connects the small diameter pulley 16 of the first belt wheel 15 to the large diameter pulley 19 of a second belt wheel 20 which is comprised of the large diameter pulley 19 and a gear 21. The gear 21 from the second belt wheel 20 then links directly with other gears 22 and ultimately the rotary cutting assembly 4. The linkage or interconnecting of gears directly with each other is readily known to those skilled in the art.

It should be appreciated that although the above discloses the use of one or two belts to couple the motor assembly and the rotary cutting assembly, more than two belts may be used. In addition, the belt assembly or assemblies may be located or connected directly to the rotary cutting shafts, or for that matter, anywhere between the rotary cutting shaft and the motor. For example, another preferred embodiment may include one belt assembly coupled directly to the motor with another belt assembly connected directly to the rotary cutting shafts. These two belt assemblies may then be coupled together with another belt assembly or intermeshing gears (not shown).

In other words, although the present invention has been described in detail with respect to certain preferred versions thereof, other versions are possible. Therefore, the scope of the claims should not be limited to the description of the preferred versions contained herein.

1. A shredder comprised of:
(a) a base and
(b) a housing;
wherein said housing contains a throat through which materials to be shredded is inserted and a shredder mechanism for shredding the material;
wherein said shredder mechanism is comprised of a rotary cutting assembly and a motor assembly coupled with at least one belt assembly.
